(19) United States
(12) Patent Application Publication
(10) Pub. No.: US 2011/0319310 A1
(43) Pub. Date: Dec. 29, 2011

(54) Stable Compositions Comprising Cationic Cellulose Polymers and Cellulase

(76) Inventor: Regine LABEQUE, Brussels (BE)

(21) Appl. No.: 13/159,448

(22) Filed: Jun. 14, 2011

(30) Foreign Application Priority Data
Jun. 24, 2010 (EP) 10167235.0

(51) Int. Cl. C11D 3/60; C11D 17/08

(52) U.S. Cl. 510/296; 510/321

(57) ABSTRACT

The need for a stable, compact composition providing improved fabric care benefit, that is also convenient to use, can be met by incorporating a cationic cellulose polymer and cellulase enzyme into a non-aqueous composition. The non-aqueous composition can be made even more convenient to use, by encapsulating in a water-soluble or dispersible film to form a unit-dose article. Such unit dose articles provide improved fabric feel in addition to improved colour maintenance.

### FIELD OF THE INVENTION

The present invention relates to stable, easy to pour, non-aqueous liquid compositions that deliver good stain removal and colour care. The invention also relates to a process for reblending compositions comprising cellulase into compositions comprising a cationic cellulose polymer.

### BACKGROUND OF THE INVENTION

Today's consumers desire liquid laundry compositions providing improved fabric care benefits, such as better fabric feel and improved colour maintenance. Cationic cellulose polymers are known in the Art for providing fabric care benefits, including softness, improved fabric maintenance, and hence also improved colour care. Cellulase enzymes improve fabric feel and colour maintenance by removing cellulose fibrils from the fibres. Since the benefits of cationic cellulose polymers and cellulase are complimentary, there is a strong desire to include both in liquid laundry compositions. However, combining these benefits into a single detergent composition is extremely challenging, since cellulases are known to degrade cationic cellulose polymers. For this reason, liquid compositions are generally formulated to avoid combinations of cellulose polymers and a cellulase enzyme. For instance, WO2004/056958 discloses pouches comprising cationic guar gum in combination with protease and amylase enzymes. WO2004/069979 and WO2007/120547 both disclose that enzyme inhibitors can be used to formulate cationic cellulose polymers and cellulase enzymes in aqueous detergent compositions. However, such solutions increase cost and manufacturing complexity. This is due to the cost of the cellulase inhibitor, but also because reblending such compositions into other formulations containing cellulose polymers, leads to degradation of the cellulose polymer, since the cellulase inhibitor is diluted to an ineffective level during reblending. Even trace amounts of cellulase enzyme have been found to degrade cellulose polymers.

Accordingly, a need remains for a means to formulate liquid compositions with cationic cellulose polymers and cellulase enzyme, without degrading the cationic cellulose polymers, or complicating reblending of cellulase enzyme containing product into cellulose polymer containing product.

### SUMMARY OF THE INVENTION

According to the present invention, there is provided a non-aqueous liquid composition comprising: a cationic cellulose polymer; and a cellulase enzyme; wherein the non-aqueous liquid composition comprises less than 20% by weight water. The present invention also provides for a process for reblending such non-aqueous liquid compositions, characterized in that the process comprises the step of combining the non-aqueous composition with another non-aqueous liquid composition which comprises a cellulose-based polymer.

### DETAILED DESCRIPTION OF THE INVENTION

The present invention solves the problem of providing a stable composition comprising both a cationic cellulose polymer and a cellulase enzyme. It has been found that by limiting the level of water in the composition, the cellulase activity is inhibited, such that it is unable to degrade the cationic cellulose polymer.

Having even trace amounts of cellulase present in an aqueous formulation leads to the degradation of cellulose polymers. Therefore, reblend of cellulase enzyme containing compositions is either impossible, or complicated. This is particularly so, since any cellulase inhibitors that may have been present are diluted to an ineffective level when the cellulase containing composition is reblended into a “fresh” composition. By limiting the water level, preferably in both the reblend and final composition, the risk of degradation of the cellulose polymer by the cellulase enzyme is eliminated.

All percentages, ratios and proportions used herein are by weight percent of the non-aqueous liquid composition. When referring to unit dose articles, all percentages, ratios and proportions used herein are by weight percent of the contents of the unit dose compartment. That is, excluding the weight of the encapsulating material. For multi-compartment unit dose articles, percentages, ratios and proportions used herein, are by weight percent of the contents of the individual unit dose compartment, unless otherwise specified.

### Non-Aqueous Liquid Compositions:

As used herein, “non-aqueous liquid composition” refers to any liquid composition comprising less than 20%, preferably less than 15%, more preferably less than 12%, most preferably less than 8% by weight of water. For instance, containing no additional water beyond what is entrained with other constituent ingredients. The term liquid also includes viscous forms such as gels and pastes. The non-aqueous liquid may include other solids or gases in suitably subdivided form, but excludes forms which are non-liquid overall, such as tablets or granules.

The non-aqueous composition of the present invention may also comprise from 2% to 40%, more preferably from 5% to 25% by weight of a non-aqueous solvent. As used herein, “non-aqueous solvent” refers to any organic solvent which contains no amino functional groups. Preferred non-aqueous solvents include monohydric alcohols, dihydric alcohols, polyhydric alcohols, glycerol, glycols including polyalkylene glycols such as polyethylene glycol, and mixtures thereof. More preferred non-aqueous solvents include monohydric alcohols, dihydric alcohols, polyhydric alcohols, glycerol, and mixtures thereof. Highly preferred are mixtures of solvents, especially mixtures of two or more of the following: lower aliphatic alcohols such as ethanol, propanol, butanol, isopropanol; diols such as 1,2-propanediol or 1,3-propanediol; and glycerol. Also preferred are propanediol and mixtures thereof with diethylene glycol where the mixture contains no methanol or ethanol. Thus embodiments of non-aqueous liquid compositions of the present invention may include embodiments in which propanediols are used but methanol and ethanol are not used.

Preferable non-aqueous solvents are liquid at ambient temperature and pressure (i.e. 21° C. and 1 atmosphere), and comprise carbon, hydrogen and oxygen. Non-aqueous solvents may be present when preparing a premix, or in the final non-aqueous composition.

### Cationic Cellulose Polymer:

The non-aqueous liquid compositions of the present invention may comprise from 0.01% to 20%, preferably from 0.1% to 15%, more preferably from 0.6% to 10% by weight of the cationic cellulose polymer.

The cationic cellulose polymer preferably has a cationic charge density of from 0.005 to 23, more preferably from 0.01 to 12, most preferably from 0.1 to 7 milliequivalents/g, at the pH of the non-aqueous liquid composition. The charge density is calculated by dividing the number of net charges per repeating unit by the molecular weight of the repeating unit. The positive charges could be located on the backbone of the polymers and/or the side chains of polymers. The term “cationic cellulose polymer” also includes amphoteric cellulose polymers that have a net positive charge at the pH of the non-aqueous liquid composition.

Suitable cationic cellulose polymers include cationic hydroxyethylcellulose and cationic hydroxypropylcellulose. Preferred cationic celluloses for use herein include those which may or may not be hydrophobically-modified, including those having hydrophobic substituent groups, having a molecular weight of from 50,000 to 2,000,000, more preferably from 100,000 to 1,000,000, and most preferably from 200,000 to 800,000. These cationic cellulose polymers have repeating substituted anhydroglucose units that correspond to the general Structural Formula I as follows:

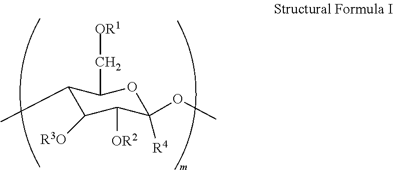

wherein:
a. m is an integer from 20 to 10,000
b. Each R⁴ is H, and R¹, R², R³ are each independently selected from the group consisting of: H; C₁-C₃₂ alkyl; C₁-C₃₂ substituted alkyl, C₅-C₃₂ or C₆-C₃₂ aryl, C₅-C₃₂ or C₆-C₃₂ substituted aryl or C₆-C₃₂ alkylaryl, or C₆-C₃₂ substituted alkylaryl, and

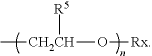

Preferably, R¹, R², R³ are each independently selected from the group consisting of: H; and C₁-C₄ alkyl;

wherein:

n is an integer selected from 0 to 10 and

Rx is selected from the group consisting of: R₅;

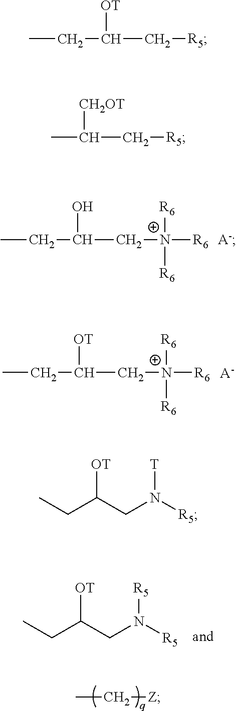

wherein at least one Rx in said polysaccharide has a structure selected from the group consisting of:

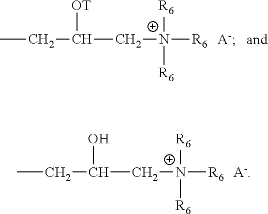

wherein A⁻ is a suitable anion. Preferably, A⁻ is selected from the group consisting of: Cl⁻, Br⁻, I⁻, methylsulfate, ethylsulfate, toluene sulfonate, carboxylate, and phosphate;
Z is selected from the group consisting of carboxylate, phosphate, phosphonate, and sulfate.
q is an integer selected from 1 to 4;
each R₅ is independently selected from the group consisting of: H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, and OH. Preferably, each R₅ is selected from the group consisting of: H, C₁-C₃₂ alkyl, and C₁-C₃₂ substituted alkyl. More preferably, R₅ is selected from the group consisting of H, methyl, and ethyl.
Each R₆ is independently selected from the group consisting of: H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, and C₆-C₃₂ substituted alkylaryl. Preferably, each R₆ is selected from the group consisting of: H, C₁-C₃₂ alkyl, and C₁-C₃₂ substituted alkyl.

Each T is independently selected from the group: H,

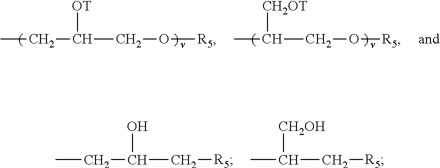

wherein each v in said polysaccharide is an integer from 1 to 10. Preferably, v is an integer from 1 to 5. The sum of all v indices in each Rx in said polysaccharide is an integer from 1 to 30, more preferably from 1 to 20, even more preferably from 1 to 10. In the last

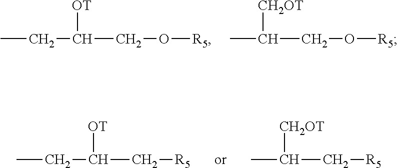

group in a chain, T is always an H.
Alkyl substitution on the anhydroglucose rings of the polymer may range from 0.01% to 5% per glucose unit, more preferably from 0.05% to 2% per glucose unit, of the polymeric material.

The cationic cellulose may be lightly cross-linked with a dialdehyde, such as glyoxyl, to prevent forming lumps, nodules or other agglomerations when added to water at ambient temperatures.

The cationic cellulose ethers of Structural Formula I likewise include those which are commercially available and further include materials which can be prepared by conventional chemical modification of commercially available materials. Commercially available cellulose ethers of the Structural Formula I type include those with the INCI name Polyquaternium 10, such as those sold under the trade names Ucare Polymer JR 30M, JR 400, JR 125, LR 400 and LK 400 polymers; Polyquaternium 67 such as those sold under the trade name Softcat SK™, all of which are marketed by Amerchol Corporation, Edgewater N.J.; and Polyquaternium 4 such as those sold under the trade name Celquat H200 and Celquat L-200 available from National Starch and Chemical Company, Bridgewater, N.J. Other suitable polysaccharides include hydroxyethyl cellulose or hydroxypropylcellulose quaternized with glycidyl C₁₂-C₂₂ alkyl dimethyl ammonium chloride. Examples of such polysaccharides include the polymers with the INCI names Polyquaternium 24 such as those sold under the trade name Quaternium LM 200, supplied by Amerchol Corporation, Edgewater N.J.

The cationic cellulose polymer can be modified to be more robust against degradation by the cellulase enzyme. For instance, it has been found that reducing the amount of unsubstituted anhydroglucose units results in a cationic cellulose polymer that is less susceptible to enzymatic degradation. This is thought to be because enzymatic chain scission primarily occurs between adjacent unsubstituted anhydroglucose units. Thus, cationic cellulose polymers, including cationic hydroxyethyl celluloses and cationic hydroxypropyl celluloses, having a high degree of molar substitution, have been found to be more resistant to degradation by cellulase enzymes. The molar substitution is the average number of substitutions per anhydroglucose repeat unit, in the cellulose backbone. Similarly, for cationic hydroxyethyl and hydroxypropyl celluloses, the molar substitution is the average number of moles of ethylene oxide and/or propylene oxide that have been reacted with each anhydroglucose repeating unit, in the cellulose backbone. Each repeating unit has three hydroxyl groups available for reaction with the ethylene oxide or propylene oxide. However, the resulting hydroxyethyl/hydroxypropyl groups also have a hydroxyl group which is available for further reaction with ethylene oxide or propylene oxide. Therefore, the molar substitution can be higher than 3.

Cationic celluloses, including cationic hydroxyethyl cellulose and hydroxypropyl cellulose, having a degree of substitution greater than 1.34 also exhibit improved resistance to degradation by the cellulase enzyme. The degree of substitution is the average number of hydroxyl groups of the anhydroglucose repeat unit, in the cellulose backbone, that have been substituted. Therefore, the degree of substitution can be a maximum of 3 for a cationic cellulose polymer. Decreased blockiness has also been found to reduce enzymatic degradation. The blockiness of a cationic cellulose polymer relates to how non-uniformly substituted is the cationic cellulose polymer. For instance, for cationic hydroxyethyl or hydroxypropyl celluloses, how non-uniformly distributed are the hydroxyethyl and/or hydroxypropyl groups along the cellulose backbone. It is believed that increasing blockiness increases the number of consecutive unsubstituted anhydroglucose repeating units available for attack by the cellulase enzyme. A measure of this non-uniformity is given by the unsubstituted trimer ratio (U3R): the ratio of unsubstituted anhydroglucose trimers to the most frequently substituted anhydroglucose trimers. The U3R is calculated by the mass spectrometric technique described in US 2006/0182703 A1 (page 4, paragraphs 48 to 56). For cationic hydroxyethyl and hydroxypropyl celluloses, the hydroxyethyl and/or hydroxypropyl molar substitution is preferably from 1.3 to 5, and the ratio of unsubstituted anhydroglucose trimers to the most frequently substituted anhydroglucose trimers is preferably lower than 0.235, more preferably lower than 0.21.

Resistance to degradation by the cellulase enzyme can also be strengthened by increased substitution at the C2 position in the anhydroglucose repeating unit. The distribution of substituents at the C2, C3 and C6 positions in the anhydroglucose repeating unit for cationic cellulose polymers, such as cationic hydroxyethyl cellulose, cationic hydroxypropyl cellulose and their derivatives, can be measured using the Lindberg method, described in Carbohydrate Research, 170 (1987) 207-214. These polymers contain eight types of anhydroglucose repeating unit, in terms of the number and location of the substituents, abbreviated as S0, S2, S3, S6, S23, S26, S36 and S236. These are defined as S0—unsubstituted anhydroglucose units; S2, S3, S6—anhydroglucose units with a single substituent at C2, C3 and C6, respectively; S23, S26, S36—anhydroglucose units with two substituents at the numbered positions; S236—anhydroglucose units with all three positions substituted. Since C3 is relatively unreactive, a measure of the increased substitution at the C2 position is given by the percentage of C2-substituted trimers (i.e. sum of S2, S23, S26, S236) relative to the percentage of C6-substituted trimers (sum of S6, S26, S36, S236). In order to enhance enzyme resistance by favoring substitution at C2, the percentage of C2-substituted trimers is preferably greater than 0.8 times, more preferably greater than 0.9 times, the percentage of C6-substituted trimers.

To further reduce any degradation due to the cellulase enzyme, the non-aqueous liquid composition may comprise the cationic cellulose polymer present in a particulate form. That is, the cationic cellulose polymer is insoluble in the non-aqueous liquid composition, or does not fully dissolve in the non-aqueous liquid composition. Suitable particulate forms include solids that are completely free of water and/or other solvent, but also includes solids that are partially hydrated and/or solvated. Partially hydrated or solvated particles are those that comprise water and/or another solvent at levels that are insufficient to cause the particles to fully solubilise. A benefit of partially hydrating and/or solvating the cationic cellulose polymer is that if any agglomerates form, they have low cake strength and are easy to redisperse. Such hydrated or solvated particles generally comprise from 0.5% to 50%, preferably 1% to 20% of water or solvent. While water is preferred, any solvent that is capable of partially solvating the cationic cellulose polymer may be used. The cationic cellulose polymer particles are preferably as small as possible. Suitable particles have an area average D90 diameter of less than 300 microns, preferably less than 200 microns, more preferably less than 150 microns. The area average D90 diameter is defined as 90% of the particles having an area smaller than the area of a circle having the diameter D90. The method for measuring the particle size is given in the Test Methods.

### Cellulase Enzyme:

For fabric feel and colour care benefits, the non-aqueous liquid composition may comprise from 0.000005% to 0.2%, preferably from 0.00001 to 0.05%, more preferably from 0.0001% to 0.02% by weight of the cellulase enzyme. However, cationic cellulose polymers have been found to be degraded even at residual levels of cellulase enzyme, in aqueous compositions. In fact, the non-aqueous liquid compositions of the present invention have been found to provide a benefit, at levels of cellulase enzyme of at least 0.0000046% by weight. Even at this low level, the cellulase enzyme has been found to degrade cationic cellulose polymers in aqueous compositions.

Suitable cellulases include endo-beta-1,4-glucanases, cellobiohydrolases and beta-1,4-glucosidases, of bacterial or fungal origin, from any family of glycosyl hydrolase showing cellulase activity. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. No. 4,435,307, U.S. Pat. No. 5,648,263, U.S. Pat. No. 5,691,178, U.S. Pat. No. 5,776,757 and WO 89/09259.

Especially suitable cellulases are the alkaline or neutral cellulases having colour care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, U.S. Pat. No. 5,686,593, U.S. Pat. No. 5,763,254, WO 95/24471, and WO 98/12307.

Commercially available cellulases include Celluzyme®, and Carezyme® (Novozymes A/S), Clazinase®, Puradax® EG-L and Puradax® HA (Genencor International Inc.), and KAC®-500(B) (Kao Corporation).

In one aspect, the cellulase can include microbial-derived endoglucanases exhibiting endo-beta-1,4-glucanase activity (E.C. 3.2.1.4), including a bacterial polypeptide endogenous to a member of the genus Bacillus which has a sequence of at least 90%, 94%, 97% and even 99% identity to the amino acid sequence SEQ ID NO:2 in U.S. Pat. No. 7,141,403 and mixtures thereof. Suitable endoglucanases are sold under the tradenames Celluclean® and Whitezyme® (Novozymes A/S, Bagsvaerd, Denmark)

Preferably, the composition comprises a cleaning cellulase belonging to Glycosyl Hydrolase family 45 having a molecular weight of from 17 kDa to 30 kDa, for example the endoglucanases sold under the tradename Biotouch® NCD, DCC and DCL (AB Enzymes, Darmstadt, Germany).

The cellulase may be intentionally formulated, or it may be introduced to the detergent composition as an impurity in another raw material, especially an enzyme. Commercial enzymes of many classes, for example protease, alpha-amylase, beta-mannanase, pectate lyase and lipase, may contain additional cellulase activity as a result of the production microorganism expressing cellulase enzymes that are not fully removed during the purification steps, or through contamination from other products during the enzyme production process. The commercial protease Purafect® Prime (Genencor Division of Danisco) is an example of a non-cellulase enzyme which typically contains significant cellulase impurities. Another source of non-intentional presence of cellulase in detergent compositions is from cross-contamination in production plants, for example when changing over from a cellulase-containing composition to one with no intentionally formulated cellulase.

### Laundering Adjuncts:

The non-aqueous liquid compositions of the present invention may include conventional laundry detergent ingredients selected from the group consisting of: anionic and nonionic surfactants; additional surfactants; other enzymes; enzyme stabilizers; cleaning polymers, including: amphiphilic alkoxylated grease cleaning polymers, clay soil cleaning polymers, soil release polymers, and soil suspending polymers; bleaching systems; optical brighteners; hueing dyes; particulate material; perfume and other odour control agents; hydrotropes; suds suppressors; fabric care benefit agents; pH adjusting agents; dye transfer inhibiting agents; preservatives; non-fabric substantive dyes and mixtures thereof. Some of the optional ingredients which can be used are described in greater detail as follows:

Anionic and nonionic surfactants: Non-aqueous liquid compositions of the present invention may comprise from 1% to 70%, preferably from 10% to 50%, and more preferably from 15% to 45% by weight of an anionic and/or nonionic surfactant.

The non-aqueous liquid compositions of the present invention preferably comprise from 1 to 70%, more preferably from 5 to 50% by weight of one or more anionic surfactants. Preferred anionic surfactant are selected from the group consisting of: C11-C18 alkyl benzene sulfonates, C10-C20 branched-chain and random alkyl sulfates, C10-C18 alkyl ethoxy sulfates, mid-chain branched alkyl sulfates, mid-chain branched alkyl alkoxy sulfates, C10-C18 alkyl alkoxy carboxylates comprising 1-5 ethoxy units, modified alkylbenzene sulfonate, C12-C20 methyl ester sulfonate, C10-C18 alpha-olefin sulfonate, C6-C20 sulfosuccinates, and mixtures thereof. However, by nature, every anionic surfactant known in the art of detergent compositions may be used, such as those disclosed in “Surfactant Science Series”, Vol. 7, edited by W. M. Linfield, Marcel Dekker. However, the compositions of the present invention preferably comprise at least one sulphonic acid surfactant, such as a linear alkyl benzene sulphonic acid, or the water-soluble salt forms.

Anionic sulfonate or sulfonic acid surfactants suitable for use herein include the acid and salt forms of linear or branched C₅-C₂₀, more preferably C10-C16, most preferably C11-C13 alkylbenzene sulfonates, C5-C20 alkyl ester sulfonates, C6-C22 primary or secondary alkane sulfonates, C5-C20 sulfonated polycarboxylic acids, and mixtures thereof. The aforementioned surfactants can vary widely in their 2-phenyl isomer content. Anionic sulphate salts suitable for use in compositions of the invention include: primary and secondary alkyl sulphates, having a linear or branched alkyl or alkenyl moiety having from 9 to 22 carbon atoms, more preferably from 12 to 18 carbon atoms; beta-branched alkyl sulphate surfactants; and mixtures thereof. Mid-chain branched alkyl sulphates or sulfonates are also suitable anionic surfactants for use in the compositions of the invention. Preferred are the C5-C22, preferably C10-C20 mid-chain branched alkyl primary sulphates. When mixtures are used, a suitable average total number of carbon atoms for the alkyl moieties is preferably within the range of from 14.5 to 17.5. Preferred mono-methyl-branched primary alkyl sulphates are selected from the group consisting of the 3-methyl to 13-methyl pentadecanol sulphates, the corresponding hexadecanol sulphates, and mixtures thereof. Dimethyl derivatives or other biodegradable alkyl sulphates having light branching can similarly be used. Other suitable anionic surfactants for use herein include fatty methyl ester sulphonates and/or alkyl ethoxy sulphates (AES) and/or alkyl polyalkoxylated carboxylates (AEC). Mixtures of anionic surfactants can be used, for example mixtures of alkylbenzenesulphonates and AES.

The anionic surfactants are typically present in the form of their salts with alkanolamines or alkali metals such as sodium and potassium. Preferably, the anionic surfactants are neutralized with alkanolamines, such as monoethanolamine or triethanolamine, and are fully soluble in the non-aqueous liquid composition.

The non-aqueous liquid compositions of the present invention may include from 1 to 70%, preferably from 5 to 50% by weight of a nonionic surfactant. Suitable nonionic surfactants include, but are not limited to C12-C18 alkyl ethoxylates (“AE”) including the so-called narrow peaked alkyl ethoxylates, C6-C12 alkyl phenol alkoxylates (especially ethoxylates and mixed ethoxylates/propoxylates), block alkylene oxide condensate of C6-C12 alkyl phenols, alkylene oxide condensates of C8-C22 alkanols and ethylene oxide/propylene oxide block polymers (Pluronic®-BASF Corp.), as well as semi polar nonionics (e.g., amine oxides and phosphine oxides). An extensive disclosure of suitable nonionic surfactants can be found in U.S. Pat. No. 3,929,678.

Alkylpolysaccharides such as disclosed in U.S. Pat. No. 4,565,647 are also useful nonionic surfactants for compositions of the invention. Also suitable are alkyl polyglucoside surfactants. In some embodiments, suitable nonionic surfactants include those of the formula R1(OC₂H₄)ₙOH, wherein R1 is a C10-C16 alkyl group or a C8-C12 alkyl phenyl group, and n is from 3 to 80. In some embodiments, the nonionic surfactants may be condensation products of C12-C15 alcohols with from 5 to 20 moles of ethylene oxide per mole of alcohol, e.g., C12-C13 alcohol condensed with 6.5 moles of ethylene oxide per mole of alcohol. Additional suitable nonionic surfactants include polyhydroxy fatty acid amides of the formula:

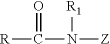

wherein R is a C9-C17 alkyl or alkenyl, R1 is a methyl group and Z is glycidyl derived from a reduced sugar or alkoxylated derivative thereof. Examples are N-methyl N-1-deoxyglucityl cocoamide and N-methyl N-1-deoxyglucityl oleamide.

Additional Surfactants: The non-aqueous liquid compositions of the present invention may comprise additional surfactant selected from the group consisting: anionic, cationic, nonionic, amphoteric and/or zwitterionic surfactants and mixtures thereof.

Suitable cationic surfactants can be water-soluble, water-dispersible or water-insoluble. Such cationic surfactants have at least one quaternized nitrogen and at least one long-chain hydrocarbyl group. Compounds comprising two, three or even four long-chain hydrocarbyl groups are also included. Examples include alkyltrimethylammonium salts, such as C12 alkyltrimethylammonium chloride, or their hydroxyalkyl substituted analogues. The present invention may comprise 1% or more of cationic surfactants.
Amphoteric detersive surfactants suitable for use in the composition include those surfactants broadly described as derivatives of aliphatic secondary and tertiary amines in which the aliphatic radical can be straight or branched chain and wherein one of the aliphatic substituents contains from 8 to 18 carbon atoms and one contains an anionic group such as carboxy, sulphonate, sulphate, phosphate, or phosphonate. Suitable amphoteric detersive surfactants for use in the present invention include, but are not limited to: cocoamphoacetate, cocoamphodiacetate, lauroamphoacetate, lauroamphodiacetate, and mixtures thereof.
Zwitterionic detersive surfactants suitable for use in non-aqueous liquid compositions are well known in the art, and include those surfactants broadly described as derivatives of aliphatic quaternary ammonium, phosphonium, and sulphonium compounds, in which the aliphatic radicals can be straight or branched chain, and wherein one of the aliphatic substituents contains from 8 to 18 carbon atoms and one contains an anionic group such as carboxy, sulfonate, sulphate, phosphate or phosphonate. Zwitterionics such as betaines are also suitable for this invention. Furthermore, amine oxide surfactants having the formula: R(EO)ₓ(PO)_{y}(BO)_{z}N(O)(CH₂R′)₂.qH2O are also useful in compositions of the present invention. R is a relatively long-chain hydrocarbyl moiety which can be saturated or unsaturated, linear or branched, and can contain from 8 to 20, preferably from 10 to 16 carbon atoms, and is more preferably C12-C16 primary alkyl. R′ is a short-chain moiety preferably selected from hydrogen, methyl and —CH₂OH. When x+y+z is different from 0, EO is ethyleneoxy, PO is propyleneneoxy and BO is butyleneoxy. Amine oxide surfactants are illustrated by C12-C14 alkyldimethyl amine oxide.

Non-limiting examples of other anionic, zwitterionic, amphoteric or optional additional surfactants suitable for use in the compositions are described in McCutcheon's, Emulsifiers and Detergents, 1989 Annual, published by M. C. Publishing Co., and U.S. Pat. Nos. 3,929,678, 2,658,072; 2,438,091; 2,528,378.

Other enzymes: The non-aqueous liquid compositions of the present invention may comprise from 0.0001% to 8% by weight of other detersive enzymes which provide improved cleaning performance and/or fabric care benefits. Such compositions preferably have a composition pH of from 6 to 10.5. Suitable enzymes can be selected from the group consisting of: lipase, protease, amylase, mannanase, pectate lyase, xyloglucanase, and mixtures thereof, in addition to the cellulase enzyme. A preferred enzyme combination comprises a cocktail of conventional detersive enzymes such as lipase, protease, and amylase. Detersive enzymes are described in greater detail in U.S. Pat. No. 6,579,839.

Enzyme Stabilizers: Enzymes can be stabilized using any known stabilizer system such as calcium and/or magnesium compounds, boron compounds and substituted boric acids, aromatic borate esters, peptides and peptide derivatives, polyols, low molecular weight carboxylates, relatively hydrophobic organic compounds [e.g. certain esters, dialkyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compound, polyamide oligomer, glycolic acid or its salts; poly hexamethylene biguanide or N,N-bis-3-amino-propyl-dodecyl amine or salt; and mixtures thereof. Any suitable cellulase inhibitor can be used. Examples of cellulase inhibitors are listed in H. Zolter, Handbook of Enzyme Inhibitors, 3ed, Part A, pp 307-309. Such cellulase inhibitors are preferably present in a level of from 0.0001% to 3% by weight of the non-aqueous composition.

Fabric Care Benefit Agents: The non-aqueous composition may further comprise from 1% to 15%, more preferably from 2% to 7%, by weight of a fabric care benefit agent, in addition to the cationic cellulose polymer and cellulase enzyme. “Fabric care benefit agent”, as used herein, refers to any material that can provide fabric care benefits. Non-limiting examples of fabric care benefits include, but are not limited to: fabric softening, colour protection, colour restoration, pill/fuzz reduction, anti-abrasion and anti-wrinkling Non-limiting examples of fabric care benefit agents include: silicone derivatives, such as polydimethylsiloxane and amino-functional silicones; oily sugar derivatives; dispersible polyolefins; polymer latexes; cationic surfactants and combinations thereof.

Cleaning Polymers: The non-aqueous liquid compositions herein, may contain from 0.01% to 10%, preferably from 0.05% to 5%, more preferably from 0.1% to 2.0% by weight of cleaning polymers that provide for broad-range soil cleaning of surfaces and fabrics. Any suitable cleaning polymer may be of use. Useful cleaning polymers are described in US 2009/0124528A1. Non-limiting examples of useful categories of cleaning polymers include: amphiphilic alkoxylated grease cleaning polymers; clay soil cleaning polymers; soil release polymers; and soil suspending polymers. Other anionic polymers, useful for improving soil cleaning include: non-silicone-containing polymers of natural origin, but also of synthetic origin. Suitable anionic non-silicone-containing polymers may be selected from the group consisting of xanthan gum, anionic starch, carboxymethyl guar, carboxymethyl hydroxypropyl guar, carboxy methyl cellulose and ester modified carboxymethyl cellulose, N-carboxyalkyl chitosan, N-carboxyalkyl chitosan amides, pectin, carrageenan gum, chondroitin sulfate, galactomanans, hyaluronic acid-, and alginic acid-based polymers, and derivatives thereof and mixtures thereof. More preferably, the anionic non-silicone-containing polymer maybe selected from carboxymethyl guar, carboxymethyl hydroxypropyl guar, carboxymethyl cellulose and xanthan gum, and derivatives and mixtures thereof. Preferred anionic non-silicone-containing polymers include those commercially available from CPKelco, sold under the tradename of Kelzan® RD and from Aqualon, sold under the tradename of Galactosol® SP722S, Galactosol® 60H3FD, and Galactosol® 70H4FD.

Optical brighteners: These are also known as fluorescent whitenening agents for textiles. Preferred levels are from 0.001% to 2% by weight of the non-aqueous liquid composition. Suitable brighteners are disclosed in EP 686691B and include hydrophobic as well as hydrophilic types. Brightener 49 is preferred for use in the present invention.

Hueing dyes: Hueing dyes or fabric shading dyes are useful laundering adjuncts in non-aqueous liquid compositions. Suitable dyes include blue and/or violet dyes having a hueing or shading effect. See, for example, WO 2009/087524 A1, WO2009/087034A1 and references therein. Recent developments that are suitable for the present invention include sulfonated phthalocyanine dyes having a zinc or aluminium central atom. The non-aqueous liquid compositions herein may comprise from 0.00003% to 0.1%, preferably from 0.00008% to 0.05% by weight of the fabric hueing dye.

Particulate material: The non-aqueous composition may include additional particulate material such as clays, suds suppressors, encapsulated oxidation-sensitive and/or thermally sensitive ingredients such as perfumes (perfume microcapsules), bleaches and enzymes; or aesthetic adjuncts such as pearlescent agents including mica, pigment particles, or the like. Suitable levels are from 0.0001% to 10%, or from 0.1% to 5% by weight of the non-aqueous composition.

Perfume and other odour control agents: In preferred embodiments, the non-aqueous composition comprises a free and/or micro-encapsulated perfume. If present, the free perfume is typically incorporated at a level from 0.001% to 10%, preferably from 0.01% to 5%, more preferably from 0.1% to 3% by weight of the non-aqueous composition. If present, the perfume microcapsule is formed by at least partially surrounding the perfume raw materials with a wall material. Preferably, the microcapsule wall material comprises: melamine crosslinked with formaldehyde, polyurea, urea crosslinked with formaldehyde or urea crosslinked with gluteraldehyde. Suitable perfume microcapsules and perfume nanocapsules include those described in the following references: US 2003215417 A1; US 2003216488 A1; US 2003158344 A1; US 2003165692 A1; US 2004071742 A1; US 2004071746 A1; US 2004072719 A1; US 2004072720 A1; EP 1393706 A1; US 2003203829 A1; US 2003195133 A1; US 2004087477 A1; US 20040106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; US RE 32,713; U.S. Pat. No. 4,234,627.

In other embodiments, the non-aqueous composition comprises odour control agents such as uncomplexed cyclodextrin, as described in U.S. Pat. No. 5,942,217. Other suitable odour control agents include those described in: U.S. Pat. No. 5,968,404, U.S. Pat. No. 5,955,093, U.S. Pat. No. 6,106,738, U.S. Pat. No. 5,942,217, and U.S. Pat. No. 6,033,679.

Hydrotropes: The non-aqueous liquid composition of the present invention typically comprises a hydrotrope in an effective amount, preferably up to 15%, more preferably from 1% to 10%, most preferably from 3% to 6% by weight, so that the compositions are readily dispersed in water. Suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, as disclosed in U.S. Pat. No. 3,915,903.

Multivalent water-soluble organic builder and/or chelant: The non-aqueous liquid compositions of the present invention may comprise from 0.6% to 25%, preferably from 1% to 20%, more preferably from 2% to 7% by weight of the multivalent water-soluble organic builder and/or chelants. Water-soluble organic builders provide a wide range of benefits including sequestration of calcium and magnesium (improving cleaning in hard water), provision of alkalinity, transition metal ion complexation, metal oxide colloid stabilisation, and provision of substantial surface charge for peptisation and suspension of other soils. Chelants may selectively bind transition metals (such as iron, copper and manganese) which impact stain removal and the stability of bleach ingredients, such as organic bleach catalysts, in the wash solution. Preferably, the multivalent water-soluble organic builder and/or chelants of the present invention are selected from the group consisting of: MEA citrate, citric acid, aminoalkylenepoly(alkylene phosphonates), alkali metal ethane 1-hydroxy disphosphonates, and nitrilotrimethylene, phosphonates, diethylene triamine penta (methylene phosphonic acid) (DTPMP), ethylene diamine tetra(methylene phosphonic acid) (DDTMP), hexamethylene diamine tetra(methylene phosphonic acid), hydroxy-ethylene 1,1 diphosphonic acid (HEDP), hydroxyethane dimethylene phosphonic acid, ethylene di-amine di-succinic acid (EDDS), ethylene diamine tetraacetic acid (EDTA), hydroxyethylethylenediamine triacetate (HEDTA), nitrilotriacetate (NTA), methylglycinediacetate (MGDA), iminodisuccinate (IDS), hydroxyethyliminodisuccinate (HIDS), hydroxyethyliminodiacetate (HEIDA), glycine diacetate (GLDA), diethylene triamine pentaacetic acid (DTPA), and mixtures thereof.

External structuring system: The non-aqueous liquid composition may also comprise an external structurant. An external structuring system is a compound or mixture of compounds which provide either a sufficient yield stress or low shear viscosity to stabilize the non-aqueous liquid compositions independently from, or extrinsic from, the structuring effect of any detersive surfactants in the composition. The non-aqueous liquid composition may comprise from 0.01% to 10%, preferably from 0.1% to 4% by weight of an external structuring system. Suitable external structuring systems include non-polymeric crystalline, hydroxy-functional structurants, polymeric structurants, or mixtures thereof.

Preferably, the external structurant system imparts a high shear viscosity at 20 s⁻¹, at 21° C., of from 1 to 1500 cps, and a viscosity at low shear (0.05 s⁻¹ at 21° C.) of greater than 5000 cps. The viscosity is measured using an AR 550 rheometer, from TA instruments, using a plate steel spindle with a 40 mm diameter and a gap size of 500 μm. The high shear viscosity at 20 s⁻¹, and low shear viscosity at 0.5 s⁻¹, can be obtained from a logarithmic shear rate sweep from 0.1 s⁻¹ to 25 s⁻¹ in 3 minutes time at 21° C.

The external structuring system may comprise a non-polymeric crystalline, hydroxyl functional structurant. Such non-polymeric crystalline, hydroxyl functional structurants generally comprise a crystallisable glyceride which can be pre-emulsified to aid dispersion into the final non-aqueous composition. Preferred crystallisable glycerides include hydrogenated castor oil or “HCO”, and derivatives thereof, provided that it is capable of crystallizing in the non-aqueous composition. Other embodiments of suitable external structuring systems may comprise a naturally derived and/or synthetic polymeric structurant. Examples of suitable naturally derived polymeric structurants include: hydroxyethyl cellulose, hydrophobically modified hydroxyethyl cellulose, carboxymethyl cellulose, polysaccharide derivatives, and mixtures thereof. Suitable polysaccharide derivatives include: pectine, alginate, arabinogalactan (gum Arabic), carrageenan, gellan gum, xanthan gum, guar gum, and mixtures thereof. Examples of suitable synthetic polymeric structurants include: polycarboxylates, polyacrylates, hydrophobically modified ethoxylated urethanes, hydrophobically modified non-ionic polyols and mixtures thereof.

### The Unit Dose Article

Non-aqueous liquid compositions of the present invention may be comprised in unit dose articles, having at least one liquid filled compartment. A liquid-filled compartment refers to a partition of the unit dose article comprising a liquid capable of wetting a fabric e.g., clothing. Such unit dose articles comprise, in single, easy to use dosage form: a cationic cellulose polymer and a cellulase enzyme, comprised in a non-aqueous composition, encapsulated in a water-soluble or dispersible film.

The unit dose article can be of any form, shape and material which is suitable for holding the non-aqueous composition, i.e. without allowing the release of the non-aqueous composition, and any additional component, from the unit dose article prior to contact of the unit dose article with water. The exact execution will depend, for example, on the type and amount of the compositions in the unit dose article, the number of compartments in the unit dose article, and on the characteristics required from the unit dose article to hold, protect and deliver or release the compositions or components.

The unit dose article comprises a water-soluble or dispersible film which fully encloses at least one inner volume, comprising the non-aqueous composition. The unit dose article may optionally comprise additional compartments comprising non-aqueous liquid and/or solid components. Alternatively, any additional solid component may be suspended in a liquid-filled compartment. A multi-compartment unit dose form may be desirable for such reasons as: separating chemically incompatible ingredients; or where it is desirable for a portion of the ingredients to be released into the wash earlier or later.

It may be preferred that any compartment which comprises a liquid component also comprises an air bubble. The air bubble may have a volume of less than 50%, preferably less than 40%, more preferably less than 30%, more preferably less than 20%, most preferably less than 10% of the volume space of said compartment. Without being bound by theory, it is believed that the presence of the air bubble increases the tolerance of the unit dose article to the movement of the liquid component within the compartment, thus reducing the risk of the liquid component leaking from the compartment.

Water-soluble or dispersible film: The water-soluble or dispersible film typically has a solubility of at least 50%, preferably at least 75%, more preferably at least 95%. The method for determining water-solubility of the film is given in the Test Methods. The water-soluble or dispersible film typically has a dissolution time of less than 100 seconds, preferably less than 85 seconds, more preferably less than 75 seconds, most preferably less than 60 seconds. The method for determining the dissolution time of the film is given in the Test Methods.

Preferred films are polymeric materials, preferably polymers which are formed into a film or sheet. The film can be obtained by casting, blow-moulding, extrusion or blow extrusion of the polymer material, as known in the art. Preferably, the water-soluble or dispersible film comprises: polymers, copolymers or derivatives thereof, including polyvinyl alcohols (PVA), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum, and mixtures thereof. More preferably, the water-soluble or dispersible film comprises: polyacrylates and water-soluble acrylate copolymers, methylcellulose, carboxymethylcellulose, dextrin, ethylcellulose, hydroxyethyl cellulose, hydroxypropyl methylcellulose, maltodextrin, polymethacrylates, and mixturest thereof. Most preferably, the water-soluble or dispersible film comprises: polyvinyl alcohols, polyvinyl alcohol copolymers, hydroxypropyl methyl cellulose (HPMC), and mixtures thereof. Preferably, the level of polymer or copolymer in the film is at least 60% by weight. The polymer or copolymer preferably has a weight average molecular weight of from 1000 to 1,000,000, more preferably from 10,000 to 300,000, even more preferably form 15,000 to 200,000, and most preferably from 20,000 to 150,000.

Copolymers and mixtures of polymers can also be used. This may in particular be beneficial to control the mechanical and/or dissolution properties of the compartments or unit dose article, depending on the application thereof and the required needs. For example, it may be preferred that a mixture of polymers is present in the film, whereby one polymer material has a higher water-solubility than another polymer material, and/or one polymer material has a higher mechanical strength than another polymer material. Using copolymers and mixtures of polymers can have other benefits, including improved long-term resiliency of the water-soluble or dispersible film to the detergent ingredients. For instance, U.S. Pat. No. 6,787,512 discloses polyvinyl alcohol copolymer films comprising a hydrolyzed copolymer of vinyl acetate and a second sulfonic acid monomer, for improved resiliency against detergent ingredients. An example of such a film is sold by Monosol of Merrillville, Ind., US, under the brand name: M8900. It may be preferred that a mixture of polymers is used, having different weight average molecular weights, for example a mixture of polyvinyl alcohol or a copolymer thereof, of a weight average molecular weight of from 10,000 to 40,000, and of another polyvinyl alcohol or copolymer, with a weight average molecular weight of from 100,000 to 300,000.

Also useful are polymer blend compositions, for example comprising hydrolytically degradable and water-soluble polymer blends such as polylactide and polyvinyl alcohol, achieved by the mixing of polylactide and polyvinyl alcohol, typically comprising 1 to 35% by weight polylactide and from 65% to 99% by weight of polyvinyl alcohol. The polymer present in the film may be from 60% to 98% hydrolysed, more preferably from 80% to 90%, to improve the dissolution/dispersion of the film material.

The water-soluble or dispersible film herein may comprise additive ingredients other than the polymer or copolymer material. For example, it may be beneficial to add: plasticisers such as glycerol, ethylene glycol, diethyleneglycol, propylene glycol, sorbitol and mixtures thereof; additional water; and/or disintegrating aids.

Other suitable examples of commercially available water-soluble films include polyvinyl alcohol and partially hydrolysed polyvinyl acetate, alginates, cellulose ethers such as carboxymethylcellulose and methylcellulose, polyethylene oxide, polyacrylates and combinations of these. Most preferred are films with similar properties to the polyvinyl alcohol comprising film known under the trade reference M8630, sold by Monosol of Merrillville, Ind., US.

### Process of Making and Reblending:

A preferred process for making a non-aqueous composition of the present invention, comprises the steps of (i) providing a non-aqueous liquid feed; (ii) combining the cationic cellulose polymer with the non-aqueous liquid feed; and (iii) combining the cellulase enzyme with the combined non-aqueous liquid feed and cationic cellulose polymer. Alternatively, the cellulase enzyme can be added before the addition of the cationic cellulose polymer. Preferably, the cationic cellulose polymer and/or the cellulase enzyme may be added as parts of premixes or as particulate dispersions. If the cationic cellulose polymer is added as part of a premix, or particulate dispersion, the premix or particulate dispersion preferably comprises from 1% to 35%, more preferably from 10% to 25% by weight of the cationic polymer. The cellulase enzyme is preferably added as a premix, including as a premix with propanediol and/or water. The cellulase premix may comprise from 5 mg/g to 50 mg/g, preferably from 10 mg/g to 20 mg/g of cationic cellulase.

The non-aqueous feed may comprise some or all of the remaining ingredients, including anionic and/or nonionic surfactants. In another embodiment, the process may include a step of forming an external structurant premix, and combining the external structurant premix with the cationic cellulose polymer, or the non-aqueous feed, or the combined cationic cellulose polymer dispersion/cellulase/non-aqueous liquid feed.

The non-aqueous liquid composition can be comprised in a unit dose article. Such unit dose article can be prepared according to methods known in the art. For instance, the water-soluble or dispersible film is cut to an appropriate size, and then folded to form the necessary number and size of compartments. The edges are then sealed using any suitable technology, for example heat sealing, wet sealing or pressure sealing. Preferably, a sealing source is brought into contact with said film, and heat or pressure is applied to seal the film material.

The water soluble or dispersible film is typically introduced to a mould and a vacuum applied so that said film is flush with the inner surface of the mould, thus forming an indent or niche in said film material. This is referred to as vacuum-forming. Another suitable method is thermo-forming. Thermo-forming typically involves the step of forming a water-soluble or dispersible film in a mould under application of heat, which allows said film to deform and take on the shape of the mould.

Typically more than one piece of water-soluble or dispersible film material is used for making the unit dose article. For example, a first piece of film material can be vacuum pulled into the mould so that said first piece of film material is flush with the inner walls of the mould. A second piece of film material can then be positioned such that it completely overlaps with the first piece of film material. The first piece of film material and second piece of film material are sealed together. The first and second pieces of water-soluble or dispersible film can be made of the same material or can be different materials.

In a process for preparing a multi-compartment unit dose article, a piece of water-soluble or dispersible film material is folded at least twice, or at least three pieces of film material are used, or at least two pieces of film material are used wherein at least one piece of film material is folded at least once. The third piece of film material, or a folded piece of film material, creates a barrier layer that, when the film materials are sealed together, divides the internal volume of the unit dose article into two or more compartments.

A multi-compartment unit dose article may also be prepared by fitting a first piece of film material into a mould. A composition, or component thereof, can then be poured into the mould. A pre-formed compartment can then be placed over the mould containing the composition, or component thereof. The pre-formed compartment also preferably contains a composition, or component thereof. The pre-formed compartment and said first piece of water-soluble or dispersible film material are sealed together to form the multi-compartment unit dose article.
The present invention also provides for a process for reblending a non-aqueous liquid composition of the present invention with a second non-aqueous composition, characterized in that the second non-aqueous composition comprises a cellulose-based polymer, preferably a cationic cellulose polymer. Alternatively, the cellulose-based polymer of the second non-aqueous composition may be an anionic cellulose polymer, such as carboxy methyl cellulose and/or ester modified carboxymethyl cellulose.

### Test Methods:

### 1) pH Measurement:

The pH is measured on the neat composition, at 25° C., using a Santarius PT-10P pH meter with gel-filled probe (such as the Toledo probe, part number 52 000 100), calibrated according to the instruction manual.

### 2) Method of Measuring Particle Size:

The Occhio Flow Cell FC200-S (Angleur, Belgium) is used to measure the particle size distribution. The sample containing the particles to be analysed is diluted to 2% by weight, using PEG200, to ensure single particle detection. 2 ml of the diluted sample is analysed according to the instructions provided with the device.

### 3) Method of Measuring the Solubility of Water-Soluble or Dispersible Films:

5.0 grams±0.1 gram of the water-soluble or dispersible film is added in a pre-weighed 400 ml beaker and 245 ml±1 ml of distilled water is added. This is stirred vigorously on a magnetic stirrer set at 600 rpm, for 30 minutes. Then, the mixture is filtered through a sintered-glass filter with a pore size of maximum 20 microns. The water is dried off from the collected filtrate by any conventional method, and the weight of the remaining material is determined (which is the dissolved or dispersed fraction). Then, the percentage solubility or dispersibility can be calculated.

### 4) Method of Measuring the Dissolution Time of Water-Soluble or Dispersible Films:

The film is cut and mounted into a folding frame slide mount for 24 mm by 36 mm diapositive film, without glass (part number 94.000.07, supplied by Else, The Netherlands, however plastic folding frames from other suppliers may be used).

A standard 600 ml glass beaker is filled with 500 ml of city water at 10° C. and agitated using a magnetic stirring rod such that the bottom of the vortex is at the height of the 400 ml graduation mark on the beaker.

The slide mount is clipped to a vertical bar and suspended into the water, with the 36 mm side horizontal, along the diameter of the beaker, such that the edge of the slide mount is 5 mm from the beaker side, and the top of the slide mount is at the height of the 400 ml graduation mark. The stop watch is started immediately the slide mount is placed in the water, and stopped when the film fully dissolves. This time is recorded as the “film dissolution time”.

### 5) Method for Assessing Softness Benefit of the Non-Aqueous Liquid Composition:

The softening performance is assessed using the following procedure: Terry cloth and knitted cotton fabrics supplied by Boechout “Beschutte Werkplaats” Company, Antwerp, Belgium, are used as test fabrics. The washing is done under standard Western European wash conditions using a Miele W467 front-loading washing machine. The wash is done using the “crease-release” cycle at 40° C., using water having a hardness of 2.5 mmol/l. The load consists of four terry swatches (plain, without woven design, 20 cm², 300 g/m²), four knitted cotton swatches (100% cotton, underwear fabric, 20 cm², 40/45 optical white, 165 to 175 g/m²), and a ballast of equal weights of pillow cases, t-shirts and terry towels to give a total wash-load of 2.5 Kg. The test-swatches are line-dried at least for 24 hours at a controlled temperature/humidity of 21° C. and 50% relative humidity.

The test fabrics are graded by two expert graders on a scale of 0 to 4, versus the control (fabrics washed under the same protocol using the reference detergent composition). The following grading scale is used:

0—No difference

1—I think I see a difference

2—I see a difference

3—I see a big difference

4—I see a very big difference.

### EXAMPLES

### Examples 1 to 3

Non-aqueous liquid compositions of the present invention comprising a cationic cellulose polymer (LK400, LR400 or JR30M) and a cellulase enzyme (Carezyme).

### Example 4

Non-aqueous liquid composition of the present invention comprising a cationic cellulose polymer (JR30M), as particulate suspension (using PEG200 as a dispersant), and a cellulase enzyme (Carezyme).

| | Example 1 | Example 2 | Example 3 | Example 4 |
|---|---|---|---|---|
| Ingredient name | WT % | WT % | WT % | WT % |
| Linear alkyl benzene sulfonic | 16.67 | 15.81 | 15.81 | 15.81 |
| acid | | | | |
| C12-14 Alkyl 3-ethoxylated | 9.72 | 9.4 | 9.4 | 9.4 |
| sulphate acid | | | | |
| C12-14 alkyl 7-ethoxylate | 14.3 | 13.84 | 13.84 | 13.84 |
| Citric acid | 0.68 | 0.66 | 0.66 | 0.66 |
| C12-18 Fatty Acid | 8.94 | 8.65 | 8.65 | 8.65 |
| DTPA (diethylene triamine | 1.18 | 1.18 | 1.18 | 1.18 |
| pentaacetic acid) | | | | |
| Carezyme | 0.0115 | 0.0115 | 0.0115 | 0.0115 |
| Polymer LK400¹ | 0.51 | — | — | 0.51² |
| Polymer LR400¹ | — | 0.51 | — | — |
| Polymer JR30M¹ | — | — | 0.51 | — |
| Pluriol E200 | — | — | — | 1.5² |
| (Polyethylenglycol 200) | | | | |
| Polyethyleneimine ethoxylate | 8 | 8 | 8 | 8 |
| PEI600 E20 | | | | |
| PEG6000-PVAc/Polyethylene | 4 | 4 | 4 | 4 |
| glycol 6000-Polyvinyl acetate | | | | |
| copolymer | | | | |
| Monoethanol amine | To pH 7.5 | To pH 7.5 | To pH 7.5 | To pH 7.5 |
| 1,2-propanediol | 11 | 11 | 11 | 11 |
| Glycerol | 5 | 5 | 5 | 5 |
| Dye | 0.01 | 0.01 | 0.01 | 0.01 |
| Water | 9.5 | 10 | 10 | 10 |
| Miscellaneous/Minors | To 100 | To 100 | To 100 | To 100 |

¹Supplied by Dow Chemicals
²LK400 in particulate form, added as a suspension in the non-aqueous dispersant (Pluriol E200)

The non-aqueous liquid compositions of examples 1 to 4 were also encapsulated in polyvinyl alcohol film (M8630, supplied by Monosol), to form liquid-containing unit dose articles.

The non-aqueous liquid compositions of examples 1 to 4, and the related unit dose articles all deliver good softening and cleaning benefit, even after long term storage (for instance, after storing 4 weeks at 35° C.).
Example 5 is a non-aqueous liquid composition of the present invention comprising a cationic cellulose polymer (LK400) and a cellulase enzyme that is resulting from reblending comparative example 1, containing an enzyme premix contaminated with cellulase enzyme, into comparative example 2, containing the cationic cellulose polymer.

| | Compar- | Compar- | |
|---|---|---|---|
| | ative | ative | |
| | Example | Example | |
| | 1 | 2 | |
| Ingredient name | WT % | WT % | Example 5 |
| Linear alkyl benzene | 15.81 | 16.67 | 16.67 |
| sulfonic acid | | | |
| C12-14 Alkyl 3-ethoxylated | 9.4 | 9.72 | 9.72 |
| sulphate acid | | | |
| C12-14 alkyl 7-ethoxylate | 13.84 | 14.3 | 14.3 |
| Citric acid | 0.66 | 0.68 | 0.68 |
| C12-18 Fatty Acid | 8.65 | 8.94 | 8.94 |
| DTPA (diethylene triamine | 1.18 | 1.18 | 1.18 |
| pentaacetic acid) | | | |
| Protease | 0.16 | — | 0.0016 |
| Mannanase | 0.0035 | — | 0.000035 |
| Amylase | 0.0234 | — | 0.000234 |
| Cellulase (as contamination) | 0.0009 | — | 0.000009 |
| LK400¹ | — | 0.51 | 0.51 |
| Polyethyleneimine ethoxylate | 8 | 8 | 8 |
| PEI600 E20 | | | |
| PEG6000-PVAc/Polyethylene | 4 | 4 | 4 |
| glycol 6000-Polyvinyl acetate | | | |
| copolymer | | | |
| Monoethanol amine | To pH 7.5 | To pH 7.5 | To pH 7.5 |
| 1,2-propanediol | 11 | 11 | 11 |
| Glycerol | 5 | 5 | 5 |
| Dye | 0.01 | 0.01 | 0.01 |
| Water | 10 | 9.5 | 9.5 |
| Miscellaneous/Minors | To 100 | To 100 | To 100 |

¹Supplied by Dow Chemicals

The resultant composition was then aged for 5 weeks at 35° C., along with the composition of comparative example 2. The softness benefit derived from both compositions was evaluated versus comparative example 1. From the table below, it can be seen that example 5 maintains its softness benefit after aging, even though it contains 0.000009% by weight cellulase enzyme.

| | PSU grading |
|---|---|
| | (vs. |
| | comparative |
| | example) |
| Comparative Example 2 | +1.0 |
| Example 5 | +0.9 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A non-aqueous liquid composition comprising:
a) a cationic cellulose polymer; and
b) a cellulase enzyme;
wherein the non-aqueous liquid composition comprises less than about 20% by weight water.

2. The non-aqueous liquid composition according to claim 1, wherein the composition comprises less than about 15% by weight of water.

3. The non-aqueous liquid composition according to claim 1, wherein the composition comprises less than about 12% by weight of water.

4. The non-aqueous liquid composition according to claim 1, wherein the composition comprises less than about 8% by weight of water.

5. The non-aqueous liquid composition according to claim 1, wherein the cationic cellulose polymer is a cationic polysaccharide.

6. The non-aqueous liquid composition according to claim 5, wherein the cationic cellulose polymer has the structural formula I: 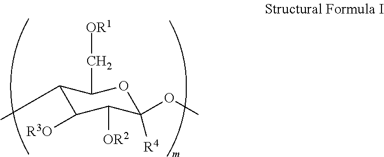
wherein:
a. m is an integer from 20 to 10,000
b. each R4 is H, and R¹, R², R³ are each independently selected from the group consisting of: H; C₁-C₃₂ alkyl; C₁-C₃₂ substituted alkyl, C₅-C₃₂ or C₆-C₃₂ aryl, C₅-C₃₂ or C₆-C₃₂ substituted aryl or C₆-C₃₂ alkylaryl, or C₆-C₃₂ substituted alkylaryl, and 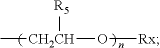
wherein:
n is an integer selected from 0 to 10 and
Rx is selected from the group consisting of: R₅; 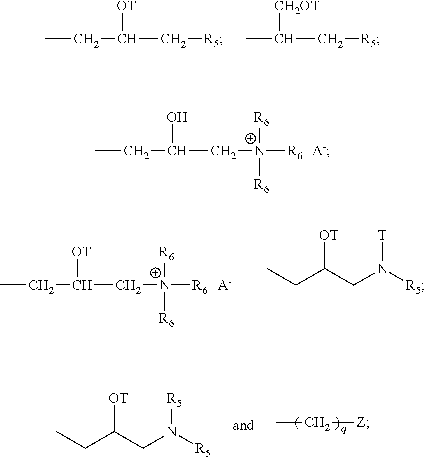
wherein at least one Rx in said polysaccharide has a structure selected from the group consisting of: 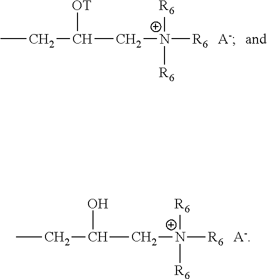
wherein A⁻ is a suitable anion.
q is an integer selected from 1 to 4;
each R₅ is independently selected from the group consisting of: H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, and OH;
each R₆ is independently selected from the group consisting of: H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, and C₆-C₃₂ substituted alkylaryl;
each T is independently selected from the group: H, 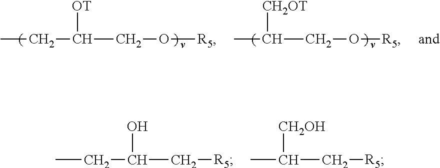
wherein each v in said polysaccharide is an integer from 1 to 10; the sum of all v indices in each Rx in said polysaccharide is an integer from 1 to 30; and in the last 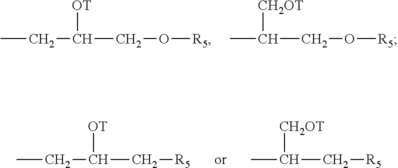
group in a chain, T is always an H.

7. The non-aqueous liquid composition according to claim 1, comprising from about 0.01% to about 20% of the cationic cellulose polymer.

8. The non-aqueous liquid composition according to claim 1, comprising from about 0.1% to about 15% by weight of the cationic cellulose polymer.

9. The non-aqueous liquid composition according to claim 1, comprising from about 0.6% to about 10% by weight of the cationic cellulose polymer.

10. The non-aqueous liquid composition according to claim 1, comprising from about 0.000005% to about 0.2% by weight of the cellulase enzyme.

11. The non-aqueous liquid composition according to claim 1, comprising from about 0.00001 to about 0.05% by weight of the cellulase enzyme.

12. The non-aqueous liquid composition according to claim 1, comprising from about 0.0001% to about 0.02% by weight of the cellulase enzyme.

13. The non-aqueous liquid laundry detergent composition according to claim 1, further comprising a cellulase inhibitor, present in a level of from about 0.0001% to about 3% by weight of the non-aqueous composition.

14. The non-aqueous liquid composition according to claim 1, wherein the cationic cellulose polymer is present in a particulate form.

15. The non-aqueous liquid composition according to claim 1, wherein the composition is enclosed in a water-soluble or dispersible film.

16. The non-aqueous liquid composition according to claim 15, wherein the water-soluble or dispersible film comprises resin selected from the group consisting of: polyvinyl alcohols, polyvinyl alcohol copolymers, hydroxypropyl methyl cellulose (HPMC), and mixtures thereof.

17. A process for reblending a non-aqueous liquid composition of claim 1 with a second non-aqueous composition, characterized in that the second non-aqueous composition comprises a cellulose-based polymer.

18. A non-aqueous liquid composition enclosed in a water-soluble or dispersible film the composition comprising:
a) a cationic cellulose polymer; and
b) a cellulase enzyme;
wherein the non-aqueous liquid composition comprises less than about 20% by weight water and the cationic cellulose polymer has the structural formula I: 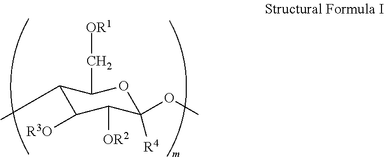
wherein:
i. m is an integer from 20 to 10,000
ii. each R4 is H, and R′, R², R³ are each independently selected from the group consisting of: H; C₁-C₃₂ alkyl; C₁-C₃₂ substituted alkyl, C₅-C₃₂ or C₆-C₃₂ aryl, C₅-C₃₂ or C₆-C₃₂ substituted aryl or C₆-C₃₂ alkylaryl, or C₆-C₃₂ substituted alkylaryl, and 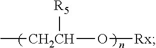
wherein:
n is an integer selected from 0 to 10 and
Rx is selected from the group consisting of: R₅; 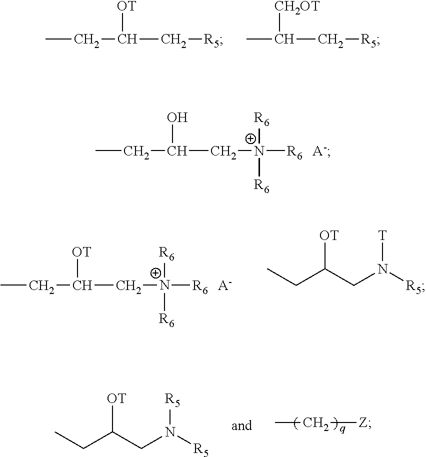
wherein at least one Rx in said polysaccharide has a structure selected from the group consisting of: 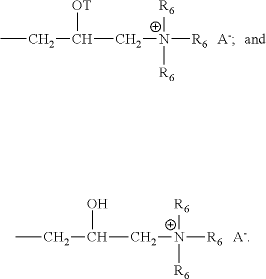
wherein A⁻ is a suitable anion.
q is an integer selected from 1 to 4;
each R₅ is independently selected from the group consisting of: H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, and OH;
each R₆ is independently selected from the group consisting of: H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, and C₆-C₃₂ substituted alkylaryl;
each T is independently selected from the group: H, 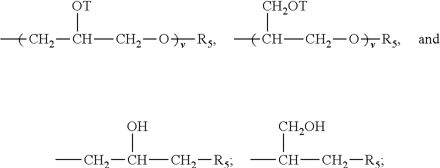
wherein each v in said polysaccharide is an integer from 1 to 10; the sum of all v indices in each Rx in said polysaccharide is an integer from 1 to 30; and in the last 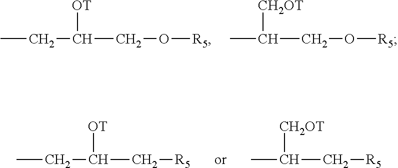
group in a chain, T is always an H; and
further wherein the water-soluble or dispersible film comprises resin selected from the group consisting of: polyvinyl alcohols, polyvinyl alcohol copolymers, hydroxypropyl methyl cellulose (HPMC), and mixtures thereof.
